(19) United States
(12) Patent Application Publication
(10) Pub. No.: US 2008/0000223 A1
(43) Pub. Date: Jan. 3, 2008

(54) Hydrodynamic Modular Unit and Method for Accelerating the Filing Process of a Hydrodynamic Modular Unit

(76) Inventors: Reinhard Kernchen, Satteldorf (DE); Karl-Heinz Diele, Satteldorf-Ellrichshausen (DE); Rolf Brockmann, Heidenheim (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/594,913

(22) PCT Filed: Mar. 22, 2005
(86) PCT No.: PCT/EP05/03012

§ 371 Date: Jul. 24, 2007

(30) Foreign Application Priority Data
Mar. 29, 2004 (DE) 10 2004 015 706.5

(51) Int. Cl. F16D 33/16

(52) U.S. Cl. 60/348; 60/363

(57) ABSTRACT

The invention relates to a hydrodynamic modular unit having two rotating impellers—a primary impeller (3) and a secondary impeller (4)—which jointly form at least one toroidal working chamber (5), having at least one inlet (6) into the toroidal working chamber (5) for operating medium and an outlet (7) out from the toroidal working chamber, the inlet (6) and the outlet (5′) being connected to each other via a circuit (8), and having an operating-medium source (10) that can be coupled to the inlet at least indirectly. The inventive hydrodynamic modular unit is characterized by the following features: means (9) for coupling the operating-medium source to the inlet and the outlet simultaneously or in a slightly time-delayed manner.

The invention relates to a hydrodynamic modular unit, in detail with the features taken from the preamble of claim 1; in addition, a method for accelerating the filling process of a hydrodynamic modular unit of this kind.

Hydrodynamic modular units are known from the prior art in a plurality of designs. When designed as a hydrodynamic coupling, they comprise a primary impeller, which functions as a pump wheel, and a secondary impeller, the two of which jointly form a toroidal working chamber. This working chamber can be filled with an operating medium, it being possible, depending on the kind of hydrodynamic component, to operate it as a hydrodynamic coupling either with constant filling or else with a variable level of filling. To the latter end, the hydrodynamic coupling with a variable level of filling is provided with an operating-medium supply and delivery system. This system comprises at least one inlet into the working chamber and an outlet out from the working chamber, the inlet being coupled to the operating-medium source at least indirectly. Preferably realized for cooling purposes is a closed circuit, which comprises the closed circuit in the working chamber and another external part, passing outside of the working chamber. The operating medium is carried in the latter from the outlet to the inlet during operation, thereby creating a kind of cooling volume flow, because the operating medium can be subjected to cooling in the external part. However, particularly when components of this kind are employed in drive systems for vehicles, it is necessary, for reasons of safety and comfort, to be able to realize the filling process in specific predetermined periods of time so as to be able to compensate for the drawback of a time delay between the requirement for start of operation of the hydrodynamic modular unit and the actual start of operation in relation to other starting units. In order to ensure this rapid filling, therefore, as a rule, an evacuation of the working chamber prior to and during the filling is undertaken, so that the air is carried out of the working chamber and does not create any resistance against the operating medium that is entering the working chamber.

For filling, the inlet or the inlets into the working chamber are coupled to an operating-medium source. It is thereby possible to influence the flow rate, depending on the design of the channels. Further known are additional measures for possible acceleration of the filling. Conceivable in this case is, for example, an evacuation of air from the working chamber, that is, evacuation for the purpose of a more rapid filling. However, it has been found that, in individual cases, the filling times attained are not adequate, so that it is necessary to search for further possibilities for increasing the rate of the filling process.

Hydrodynamic modular units having this associated operating-medium supply system are known in prior art, for example, from the following publications:

1. DE 100 46 833 A1

2. DE 1 140 595

3. DE 199 09 690 C2

4. DE 692 30 604 T2

5. DE 25 28 857 A1

6. DE 32 11 337 A1

Described in these publications are various operating-medium supply systems by means of which the filling and draining of the hydrodynamic components is ensured. The individual systems here have a very complex construction and are characterized, as a rule, by a high cost in terms of control engineering. However, all of them have the same drawback, namely, that the filling times for individual application cases are often inadequate.

The invention is therefore based on the problem of developing a method and a device for increasing the rate of the filling process after a standstill or after the draining of a hydrodynamic modular unit, in particular a hydrodynamic coupling, said process being characterized in comparison to the prior art by shorter filling times and having a low cost in terms of control engineering.

The inventive solution is characterized by the features of claims 1 and 19. Advantageous embodiments are described in the subclaims.

The hydrodynamic modular unit, in particular a hydrodynamic coupling, comprises at least two impellers, a primary impeller and a secondary impeller, which jointly form a toroidal working chamber. Provided for the operating medium are at least one inlet into the working chamber and at least one outlet out from the working chamber. The inlet and the outlet are coupled together via a circuit. Furthermore, the inlet can be connected at least indirectly to an operating-medium source in order to ensure a filling. Provided in accordance with the invention are means for connecting the inlet and the outlet to the operating-medium source simultaneously or in a slightly time-delayed manner.

The inventive solution makes it possible to accomplish the filling process in a rapid and simple manner, particularly after a standstill of the hydrodynamic coupling and/or a draining of the hydrodynamic coupling, based on the exploitation, without anything further, of an already present line region, which is used in the main working range essentially for discharging operating medium from the working chamber and for delivery. In the process, the normal filling pathway is used, on the one hand, and further, an additional filling segment is provided.

In accordance with a first solution approach, a suitable coupling between the operating-medium source and the inlet brings about simultaneously an automatic start of the filling operation via the outlet from the working chamber. The working chamber is thereby filled with operating medium simultaneously via the inlet and the outlet. After the creation of a meridional flow and the establishment of system pressures, at least one of which, a parameter characterizing at least indirectly the pressure in the working chamber, corresponds to a limit value that imposes the normal flow direction on the cooling volume flow established between the outlet and inlet into the working chamber. In this case, no additional functional elements are required. Therefore, this solution can also be employed without further modifications for hydrodynamic couplings having a closed circuit and a coupling of the operating-medium source to the closed circuit.

Provided in accordance with a further second solution approach are corresponding means for the selective coupling of the outlet to the operating-medium source. In the simplest case, these functions are accomplished via corresponding valve. These latter devices can be arranged in the connection between the operating-medium source to the inlet and/or in the connection of the operating-medium source to the outlet. The concrete design of these valve devices lies in the normal field of activity of the competent practitioner, for which reason the very diverse possibilities will not be addressed in detail here.

Finding use as an operating-medium source is preferably a vessel that can be filled with operating medium, which is preferably coupled to the circuit between the outlet and inlet into the working chamber in a pressure-tight manner. The linkage is preferably made in a pressure-tight manner. The application of a control pressure on the level of operating medium in the vessel produces a static superimposed pressure on the pressure in the closed circuit. This control pressure serves to control the level of filling. The vessel can be formed, for example,
a) from the gear housing or a partial region of the gearbox and/or
b) from the housing of a starting unit, and/or
c) a separate vessel, which is provided for the hydrodynamic component and spatially separated from it.

Preferably, though, the already present gear oil sump is used, without anything further.

As a rule, a multiplicity of inlets and outlets are provided into the working chamber and out of the working chamber, respectively. These can be coupled preferably via a respective ring channel. The ring channel, in turn, is linked to the external part of the closed circuit. There exists a plurality of possibilities with respect to the passage of the external part of the closed circuit. This can be set up in the housing of the hydrodynamic components or else outside of it.

The inlets into the working chamber can be arranged here in the region of the blade base or else in the region of the blade ends. In the latter case, corresponding channels, which allow the operating medium to be carried through the wall of the impellers to the blade ends, are provided in the blades or on the blades. The inlet then is set up preferably in the core chamber in the region of the lowest static pressure.

The inventive solution is explained below on the basis of figures. Depicted therein in detail is the following:

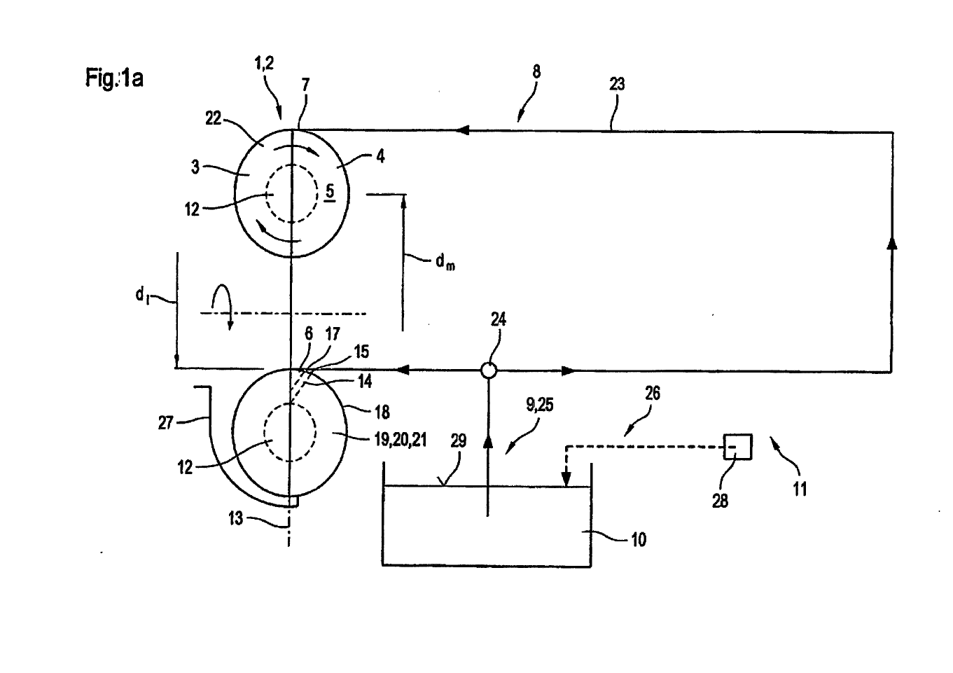

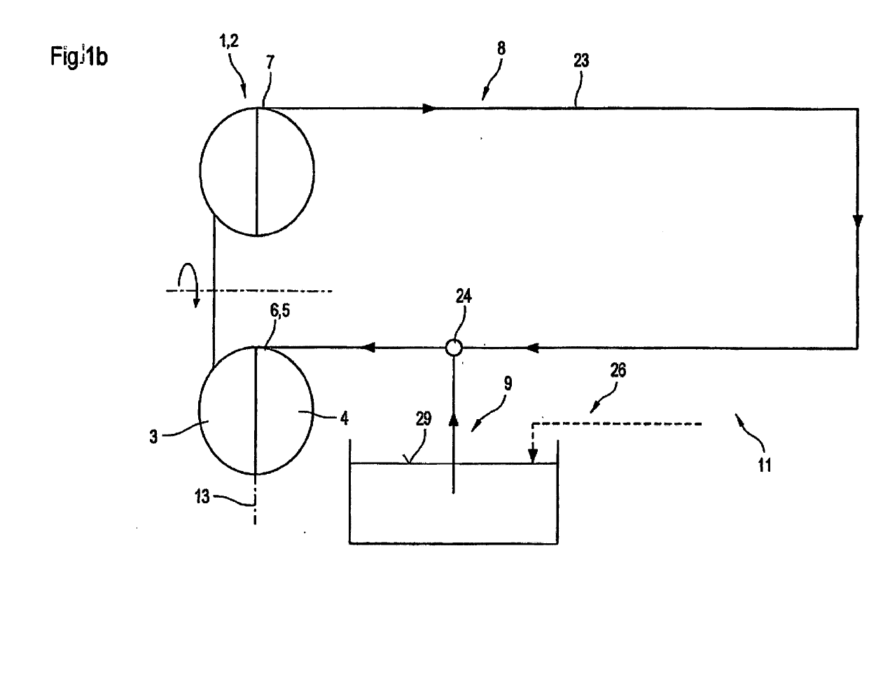

FIGS. 1a and 1b illustrate, in a schematically simplified depiction, the basic structure of a hydrodynamic modular unit with automatic disconnection of the outlet from the operating-medium source in two operating states;

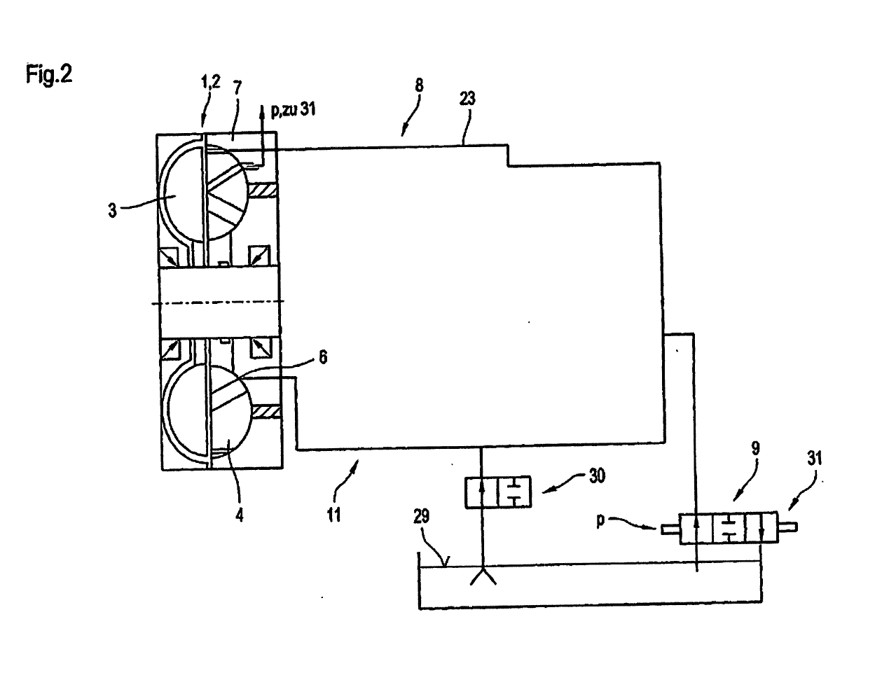

FIG. 2 illustrates a second solution approach with separate means for the selective coupling of the outlet to the operating-medium source.

FIGS. 1a and 1b illustrate, in a schematically simplified depiction, the basic structure of an inventively designed hydrodynamic modular unit 1 in the form of a hydrodynamic coupling 2. The latter comprises a primary impeller 3 and a secondary impeller 4. Here, as a rule, the primary impeller 3 is coupled at least indirectly to a drive or a drive engine, respectively, when it is used in driving units, and functions as a pump wheel during power transmission from it in the direction of the hydrodynamic coupling 2, whereas the secondary impeller 4 functions as a turbine wheel in this functional state. The primary impeller 3 and the secondary impeller 4 form a working chamber 5 that can be filled with operating medium. The latter is preferably constructed in a toroidal shape. The filling can either occur once in the case of a design as a constantly filled coupling or else can be continually varied. Associated with the working chamber 5 are at least one inlet 6 into it and one outlet 7 out from it. Inlet 6 and outlet 7 are coupled together via a circuit 8 in the form of a closed circuit, a coolant flow being maintained via the circuit 8 during the operation of the hydrodynamic coupling 2 and making possible a discharging of operating medium from the working chamber 5 for the purpose of cooling by at least intermittent passage outside of the working chamber 5 and a compensation by renewed, that is, simultaneous, delivery of operating medium from the circuit 8 into the working chamber 5. Preferably, a multiplicity of inlets and outlets are provided, each of which can be coupled respectively, with a of ring channel, which, in turn, is coupled, to the circuit. In the following, one inlet and one outlet will be discussed for simplification. Accomplished via the inlet 6, as a rule, is the refilling after a standing still or after a draining of the hydrodynamic coupling 2. Provided for accelerating the filling process in accordance with the invention are means 9, which make possible a connection of inlet 6 and outlet 7 to an operating-medium source 10 simultaneously or in a slightly time-delayed manner. The latter is a component of an operating-medium delivery and supply system 11, to which the circuit 8 also belongs. The means for connection of inlet 6 and outlet 7 to the operating-medium source 10 simultaneously or in a slightly time-delayed manner can be designed in a variety of ways. Their design and construction depends on the design of the operating-medium supply and delivery system 11. In the simplest case, no separate elements whatsoever are provided and the operating-medium source 10 is connected only via a single connecting line to the circuit 8. The simultaneous filling both via the inlet(s) 6 and the outlet(s) 7 occurs until a meridional flow has been created in the working chamber 5 and simultaneously the system pressures that thereby ensue are active and impose the normal flow direction on the cooling oil volume flow via the circuit 8 from the working chamber 5 of the hydrodynamic coupling 2 once again to the inlet 6 into the working chamber 5. The circuit part that adjoins the outlet(s) 7 and extends to the connecting line to the closed circuit 8 is then no longer usable as a filling segment. This solution offers the advantage that, in this case, no additional assemblies are to be provided and, furthermore, on account of the ratios that are established in the overall system, the filling via the outlet 7 automatically ceases operation with the system pressures that are established in the coupling 2. FIG. 1a illustrates the flow of operating medium during the filling process, while FIG. 1b reproduces, on the basis of arrows, the passage of operating medium in normal operation of the hydrodynamic coupling 2 after decoupling of the outlet 7 from the operating-medium source 10.

Preferably, the filling occurs into the core chamber 12 of the working chamber 5. Core chamber 12 is understood here to refer to a region arranged in the toroidal working chamber 5 in its center, as viewed in cross section through the hydrodynamic coupling 2, or, in other words, can be described, in terms of its position in the region of a dividing plane 13 between the primary impeller 3 and the secondary impeller 4, by way of the center diameter dₘ of the toroidal working chamber 5. This represents the region of lowest static pressure as well. The core chamber 12, as a rule, is determined by the diameter of the area bisector of the working chamber. For this purpose, the inlet 6 is coupled via at least one channel 14 with a so-called filling chamber 15, which is associated with the hydrodynamic coupling 2. The latter chamber is preferably arranged in the region within the central diameter dₘ of the toroidal working chamber as viewed in the radial direction. Preferably, the filling chamber 15 is arranged in the region of the inner diameter dᵢ of the toroidal working chamber 5 and is coupled to a corresponding operating-medium delivery and supply system 11. The filling chamber 15 is constructed, for example, as a collecting channel 16, which can bear blades oriented in the flow direction. The filling chamber 15 is located outside of the toroidal working chamber 5 and is connected to the inlet 6 via the channel 14. Here, the channel 14 extends through the wall 18 of one of the impellers and through one blade 19 of the blading system 20, for example, or of the secondary impeller 4, preferably the primary impeller 3. Here, the construction of the channel 14 into the core chamber 12 depends on the arrangement of the filling chamber 15 in relation to the toroidal working chamber 5. The case depicted in accordance with FIG. 1a illustrates an advantageous embodiment in which the filling chamber 15 is arranged below the central diameter dₘ of the toroidal working chamber 5 in the radial direction, preferably in the region of the inner diameter dᵢ. The arrangement of the filling chamber 15 occurs in the axial direction in the region between the dividing plane 13 and the outer dimensions in the axial direction of the corresponding impeller—here, the primary impeller 3. In the case depicted, this results, in essence, in a channel passage for the channel 14 at an angle of from 20 degrees up to and including 70 degrees. The passage of the channel 14 through a blade 19 of the blading system 20 occurs here preferably in the region of the back side of the blade 21. There thereby exists the possibility of incorporating the channel 14 into a standard already present blade 19 of the blading system 20 without anything further or else of specially designing the blade that carries the channel 14 in accordance with this function so that it differs from the other blades of the blading system 20 in terms of its construction.

Provided in accordance with an especially advantageous aspect of the invention is not only a corresponding inlet 6 into the working chamber, but a multiplicity of inlets of this kind. Here, the individual inlets are connected to the filling chamber 15 via corresponding channels 14. Preferably, the individual channels 14 are then coupled together via a ring channel 17, which can be formed from the filling chamber 15. The operating medium, in particular oil, or water in the case of water couplings, can be pressure-free or else subjected to a pressure.

According to an especially advantageous embodiment, the filling occurs for a hydrodynamic coupling 2 having a closed circuit 8 by imposing a static superimposed pressure on the operating-medium flow that is established in the circuit 8. Here, this circuit comprises the working circuit 22 that is established in the toroidal working chamber 5 and a part 23, which passes outside of the working chamber 5 and is connected to the inlet 6 into the working chamber 5 and at least to one outlet 7. The closed circuit 8 can be coupled via a junction 24 with means 25 for filling and/or draining and means 26 for creating a pressure influencing the pressure in the closed circuit 8. Here, the housing 27 provided for the hydrodynamic coupling 2 is coupled to the primary impeller 3 in a manner that is resistant to rotation or else designed as a stationary housing. In both cases, corresponding gaskets are provided for realizing the circuit 8. This closed circuit 8 is a component of the operating-medium supply and delivery system 11 and can be coupled to additional connecting lines—in this case, particularly to the means 25 for filling and/or draining or else to the operating-medium source 10, respectively.

The means 25 for filling and/or draining comprise means 26 for creating a pressure for influencing the pressure in the closed circuit 8. Functioning as an operating-medium source, for example, is a tank or else, in the simplest case, the oil sump of a starting unit in which the hydrodynamic coupling 2 is integrated or else the gear oil sump of a gearbox in which the hydrodynamic coupling 2 is incorporated.

Here, the means 26 for creating a pressure for influencing the pressure in the closed circuit 8 comprise means 28 for creating a pressure on the operating-medium level 29 of the operating medium, in particular of the gear oil sump or the oil sump in the starting unit.

The inventive solution is suitable, in an especially advantageous way, for designs that are characterized by a closed circuit 8 in the operating-medium delivery and/or supply system 11, it being possible to superimpose a pressure for influencing the pressure thereof in a simple way. This applies, in particular, to designs for which the filling can be controlled via a pressure on a static operating-medium level. However, it is also conceivable that the means 25 for filling and/or draining comprise valve devices that are associated with the inlet 6 and the outlet 7, respectively, in such a way that these valve devices can be actuated jointly or else separately in the connection with an operating-medium storage device or an operating-medium source. Preferably, here, the respective valve devices 30 and 31 are provided for the inlet 6 and the outlet 7 and, for the purpose of filling, that is, after a corresponding signal for a desired starting operation of the hydrodynamic coupling exists after a standing still or a draining, couple the outlet(s) 7 to the operating-medium source 10 in addition to the already present connection of the operating-medium source to the inlet 6. The valve device is preferably designed in such a way that, for the control thereof, a pressure is imposed on it, this pressure being describable by the system pressures or by at least one system pressure in the working chamber 5. In accordance therewith, at a given point in time when a specific system pressure is attained in the working chamber 5, this pressure preferably corresponding to a pressure that makes it necessary to deliver the operating medium externally of the working circuit for purposes of cooling, the valve device 31 arranged in the connection between outlet 7 and the operating-medium source 10 is subjected to pressure in such a way that the outlet 7 is coupled once again, at least indirectly, to the inlet 6 via the external part 23 of the circuit 8 and no supply of the outlet 7 from the operating-medium source 10 occurs. A design of this kind is depicted, by way of example, in FIG. 2. The valve device 31 is designed, by way of example, as a 3/2-way valve. The valve device 30 is constructed as a 2/2-way valve.

The inventive solution is not limited to the designs represented, by way of example, in FIGS. 1 and 2. The concrete embodiment depends on the particular features of the operating-medium supply and delivery system. Decisive is that an additional utilization of the outlet(s) 7 occurs for purposes of filling.

### LIST OF REFERENCE NUMERALS

1 hydrodynamic component
2 hydrodynamic coupling
3 primary impeller
4 secondary impeller
5 toroidal working chamber
6 inlet
7 outlet
8 circuit
9 means for connection of the inlet and the outlet to an operating-medium source simultaneously or in a slightly time-delayed manner
10 operating-medium source
11 operating-medium delivery and supply system
12 core chamber
13 dividing plane
14 channel
15 filling chamber
16 collecting channel
17 ring channel
18 wall
19 blade
20 blading system
21 back side of blade
22 working circuit
23 external part of the closed circuit
24 junction
25 means for filling and/or draining
26 means for creating a pressure for influencing the pressure in the closed circuit
27 housing
28 means for creating a pressure on the operating-medium level
29 operating-medium level
30 valve device
31 valve device

1.-21. (canceled)

22. A hydrodynamic modular unit comprising:
a primary impeller;
a secondary impeller, said primary and secondary impellers forming at least one working chamber that can be filled with operating medium;
a first inlet allowing the operating medium into said working chamber;
a first outlet allowing the operating medium out of said working chamber;
a second inlet, wherein said second inlet and said first outlet are coupled together via a circuit, and wherein said first inlet can be coupled to said second inlet;
a first device for connecting said second inlet and said first outlet to said first inlet simultaneously or with a pre-determined time dely, in order to fill said working chamber simultaneously by said first inlet and a second outlet, wherein said first device comprises:
a first valve arranged in connection between said first inlet and said first outlet, wherein said first valve has a first switching position for connecting said first outlet to said first inlet, and wherein said first valve has a second switching position for breaking the connection between said first outlet and said first inlet.

23. The hydrodynamic modular unit of claim 22, wherein said circuit is designed as a closed circuit, wherein said first device comprises a second device for filling and/or draining which is connected to said circuit, and wherein said second means comprises a third device for creating a pressure for influencing pressure in said circuit.

24. The hydrodynamic modular unit of claim 23, wherein said second device comprises a pressure-generating device which applies a static superimposed pressure on a static operating-medium level of said first inlet.

25. The hydrodynamic modular unit of claim 24, wherein said first inlet is formed by an operating-medium storage vessel in the form of a tank.

26. The hydrodynamic modular unit of claim 24, wherein said first inlet is formed by an oil sump disposed in a housing of a gear modular unit or in a housing of a starting unit.

27. The hydrodynamic modular unit of claim 23, wherein said second device is connected to said circuit in a liquid-tight and pressure-tight manner, except in the case of an evacuation.

28. The hydrodynamic modular unit of claim 22, wherein said first device comprises a second valve arranged between said first and second inlets, said second valve leading into said working chamber.

29. The hydrodynamic modular unit of claim 22, wherein said second inlet is arranged in a region of lowest static pressure.

30. The hydrodynamic modular unit of claim 29, wherein said second inlet is arranged in a core chamber in a region of a central diameter of said working chamber and in a region of a dividing plane between said primary and secondary impellers.

31. The hydrodynamic modular unit of claim 30, wherein said core chamber is within said working chamber.

32. The hydrodynamic modular unit of claim 29, wherein said second inlet is arranged on a first blade of a blading system on either said primary or said second impellers.

33. The hydrodynamic modular unit of claim 32, wherein said second inlet is arranged in an end region of said first blade.

34. The hydrodynamic modular unit of claim 32, further comprising:
an operating-medium delivery or filling chamber being connected to said second inlet via a channel.

35. The hydrodynamic modular unit of claim 34, wherein said channel is incorporated into said first blade.

36. The hydrodynamic modular unit of claim 35, wherein said operating-medium delivery or filling chamber is arranged on an outer circumference of a blade wheel in a radial direction below a central diameter of said working chamber, wherein said channel extends from said operating-medium delivery or filling chamber through a wall of said blade wheel to or through a second blade of said blading system in a direction of said central diameter into a region of a dividing plane between said primary and secondary impellers and up to an end of said second blade.

37. The hydrodynamic modular unit of claim 34, further comprising:
a plurality of said second inlets being associated with a plurality of said channels, wherein each one of said plurality of channels is connected together via a ring channel.

38. The hydrodynamic modular unit of claim 37, wherein said ring channel is formed by said operating-medium delivery or filling chamber.

39. The hydrodynamic modular unit of claim 22, wherein the hydrodynamic modular unit is a hydrodynamic coupling, wherein said primary impeller functions as a pump wheel, and wherein said secondary impeller functions as a turbine wheel, said hydrodynamic coupling being free of a guide wheel.

40. A method for accelerating the filling process of a hydrodynamic modular unit, comprising:
receiving a signal that a desired filling operation has been accomplished and in response to said signal, coupling of the hydrodynamic modular unit to an operating-medium source after a standing still or in a drained state for filling of an inlet and an outlet simultaneously or in a time-delayed manner;
filling of a working chamber with operating medium simultaneously through said inlet and said outlet;
establishing a flow circuit in said working chamber;
establishing a parameter of specific magnitude of a pressure in said working chamber; and
decoupling said outlet from said operating-medium source.

41. The method according to claim 40, wherein the decoupling step is accomplished via a valve device, said valve device being subjected to an actuating pressure resulting from the pressure in said working chamber.
